(19) United States
(12) Patent Application Publication
(10) Pub. No.: US 2026/0260662 A1
(43) Pub. Date: Sep. 3, 2026

(54) ELECTRONIC APPARATUS AND VOICE PROCESSING METHOD

(71) Applicant: Lenovo Japan LLC, Tokyo (JP)

(72) Inventors: Dadao Tian, Kanagawa (JP); Qian Wang, Kanagawa (JP); Xueyong Yang, Kanagawa (JP); Kiyo Moriguchi, Kanagawa (JP)

(73) Assignee: Lenovo Japan LLC, Tokyo (JP)

(21) Appl. No.: 19/448,681

(22) Filed: Jan. 14, 2026

(30) Foreign Application Priority Data
Mar. 3, 2025 (JP) 2025-032593

(51) Int. Cl. G10L 21/0216

(52) U.S. Cl. CPC G10L 21/0216; G10L 2021/02165

(57) ABSTRACT

An electronic apparatus includes an interface to which a first microphone is connectable, a second microphone, and a controller. The controller is configured to remove an environmental sound component that is a component separate from a speech voice from a first voice signal picked up from the first microphone and a second voice signal picked up from the second microphone and acquire a first output signal and a second output signal. The controller is further configured to subtract a larger amount of the second output signal from the first output signal to acquire an output signal as a level difference between the first voice signal and the second voice signal is larger.

### CROSS-REFERENCE TO RELATED APPLICATIONS

This application claims priority to Japanese Patent Application No. 2025-032593 filed on Mar. 3, 2025, the contents of which are hereby incorporated herein by reference in their entirety.

### TECHNICAL FIELD

The present application relates to an electronic apparatus and a voice processing method, for example, noise cancellation when using a headset.

### BACKGROUND

A voice call may be made by using an electronic apparatus such as a personal computer (PC). The electronic apparatus picks up a speech voice of a user and transmits it to a communication partner. When picking up the speech voice, a microphone (in the present application, may be called “built-in microphone”) built into the electronic apparatus may be used, or a headset may be used separately from the built-in microphone. The headset is configured by arranging receivers and a microphone (in the present application, may be called “headset microphone”) in a headband wearable on a head of the user. In a state where the headset is worn on the head of the user, the receivers are arranged at positions at which ears of the user are covered, and the headset microphone is arranged at a fixed distance from the front of a mouth of the user. For that reason, a surrounding environmental sound other than the user's own speech voice is also picked up by the headset microphone, and thus the clarity of the speech voice may be impaired. The environmental sound is not limited to an operating sound of an apparatus such as an air conditioner and a printer, and may also include a speech voice of another person other than the user.

Any of electronic apparatuses may have a noise canceling function. For example, a mobile terminal disclosed in Japanese Unexamined Patent Application Publication No. 2014-003532 has a noise canceling function, and includes in a main body a first microphone for picking up a transmitted voice of a user during a call by the user, a built-in second microphone for picking up an environmental sound, and a battery pack that supplies the required power and an output signal of the second microphone to the main body.

However, the electronic apparatus having a noise canceling function, such as the mobile terminal disclosed in Japanese Unexamined Patent Application Publication No. 2014-003532, is designed to achieve the practical amount of attenuation of ambient noise with respect to a voice signal picked up by a built-in microphone. An external microphone separate from the built-in microphone may not be able to sufficiently reduce a surrounding environmental sound due to differences in the sensitivity and configuration.

### SUMMARY

An electronic apparatus according to one or more embodiments of the present application includes: an interface to which a first microphone is connectable; a second microphone; and a controller configured to remove an environmental sound component that is a component separate from a speech voice from a first voice signal picked up from the first microphone and a second voice signal picked up from the second microphone to acquire a first output signal and a second output signal, and the controller is configured to subtract a larger amount of the second output signal from the first output signal to acquire an output signal as a level difference between the first voice signal and the second voice signal is larger.

In the above electronic apparatus, the controller may be configured to: previously set a sensitivity for each of models of the first microphone; determine, among the models, a model of the first microphone when detecting connection with the first microphone; and acquire the first voice signal based on the sensitivity of the model.

In the above electronic apparatus, the controller may be configured to: detect connection between the first microphone and the interface; and determine the model of the first microphone based on device information input from the first microphone.

In the above electronic apparatus, the first microphone may be arranged integrally with a reproduced sound source that is wearable on a head of a user.

In the above electronic apparatus, the controller may be configured to: acquire a weighted residual of the second output signal from the first output signal as the output signal; and set a weight coefficient in the weighted residual for the second output signal so that the output signal is canceled when a user does not speak and another sound source pronounces.

A voice processing method, according to one or more embodiments of the present application, for an electronic apparatus that includes an interface to which a first microphone is connectable and a second microphone, comprising: removing an environmental sound component that is a component separate from a speech voice from a first voice signal picked up from the first microphone and a second voice signal picked up from the second microphone to acquire a first output signal and a second output signal, and subtracting a larger amount of the second output signal from the first output signal to acquire an output signal, as a level difference between the first voice signal and the second voice signal is larger.

According to one or more embodiments, the present application can reduce an environmental sound even when using the first microphone that is an external microphone to clearly acquire a speech voice of a user.

### BRIEF DESCRIPTION OF THE DRAWINGS

FIG. 1 is a perspective diagram illustrating an exterior configuration example of an electronic apparatus according to one or more embodiments;

FIG. 2 is a schematic block diagram illustrating a hardware configuration example of the electronic apparatus according to one or more embodiments;

FIG. 3 is a diagram exemplifying a positional relationship between a headset microphone, a built-in microphone, and a user who is a sound source according to one or more embodiments;

FIG. 4 is a diagram exemplifying distance dependency of a received sound level of a speech voice of the user who is a sound source according to one or more embodiments;

FIG. 5 is a diagram exemplifying a first voice signal picked up by the headset microphone according to one or more embodiments;

FIG. 6 is a diagram exemplifying a second voice signal picked up by the built-in microphone according to one or more embodiments; and

FIG. 7 is a flowchart exemplifying voice processing according to one or more embodiments.

### DETAILED DESCRIPTION

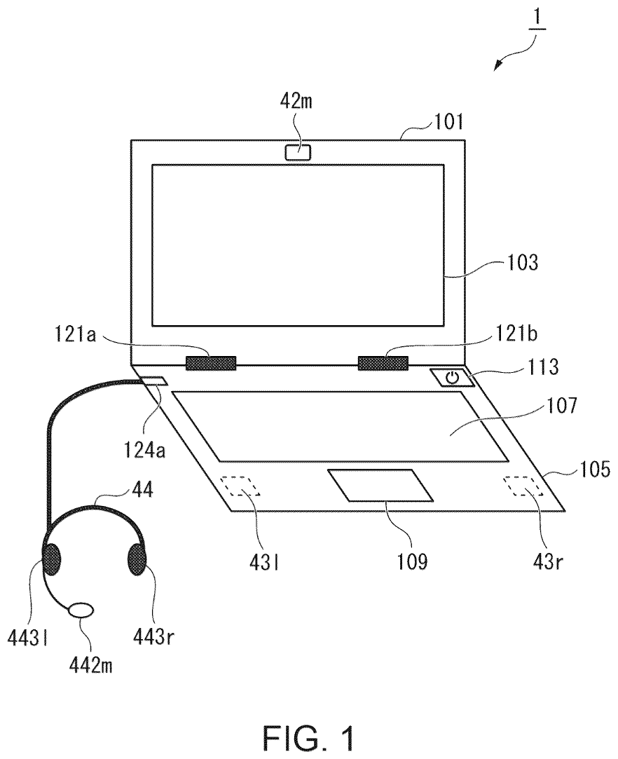

Hereinafter, embodiments of the present application will be described with reference to the accompanying drawings. First, the overview of an electronic apparatus 1 according to one or more embodiments will be described. FIG. 1 is a perspective diagram illustrating an exterior configuration example of the electronic apparatus 1 according to one or more embodiments. In the example of FIG. 1, the electronic apparatus 1 is configured as a laptop personal computer (laptop PC).

The electronic apparatus 1 includes a first chassis 101 and a second chassis 105, and these chassis are joined together by using hinge mechanisms 121a and 121b. The hinge mechanisms 121a and 121b are fixed to one side of the first chassis 101 and one side of the second chassis 105. One of the first chassis 101 and the second chassis 105 is rotatable relatively to the other by using the one sides of the first chassis 101 and the second chassis 105 as a rotation axis. In other words, an angle θ (in the present application, called “opening angle”) between a principal surface of the first chassis 101 and a principal surface of the second chassis 105 is variable.

A display 103 is arranged on the principal surface of the first chassis 101 to occupy most thereof. A keyboard 107, a touch pad 109, and a power button 113 are arranged on the principal surface of the second chassis 105. Built-in speakers 431 and 43r are respectively embedded on the left and right sides of the touch pad 109. With this arrangement, the electronic apparatus 1 is used in a state where the first chassis 101 and the second chassis 105 are open. The open state is a state where one of the principal surface of the first chassis 101 and the principal surface of the second chassis 105 is open and is not shielded by the other. In the open state, the opening angle θ typically is in a range of 90° to 180°.

An audio connector 124a is provided on a side surface of the second chassis 105. The audio connector 124a is an input-output interface that is detachably connected to an input/output terminal of an audio device by external force. The audio connector 124a has a shape that can be fitted into the input/output terminal of the audio device, and enables voice signals of the electronic apparatus 1 to be input and output in a state where the connector is fitted into the input/output terminal. In the example of FIG. 1, the audio connector 124a includes an audio jack. A headset 44 is connected as the audio device, and an audio plug is provided as the input/output terminal. The audio plug is inserted into a cavity of the audio connector 124a, and voice signals are input and output between the audio plug and the audio connector 124a. The audio connector 124a is not limited to the audio jack, and may be a USB receptacle, for example. In that case, the headset only needs to have a USB plug as the input/output terminal.

The headset 44 includes two receivers 4431 and 443r and a headset microphone 442m. The receivers 4431 and 443r are reproduced sound sources that are provided on both ends of a stretchable headband. One end and the other end of the headband adhere to back surfaces of the receivers 4431 and 443r. One end of a boom arm is supported on the back surface of the receiver 4431. The headset microphone 442m is provided on the other end of the boom arm. The boom arm enables the direction and length around a rotation axis passing through the receivers 4431 and 443r to be changed. Therefore, in a state where the headband is worn on a head of a user, the fronts of the receivers 4431 and 443r are pressed against the left and right ears of the user, and the headset microphone 442m is arranged in the front of a mouth of the user.

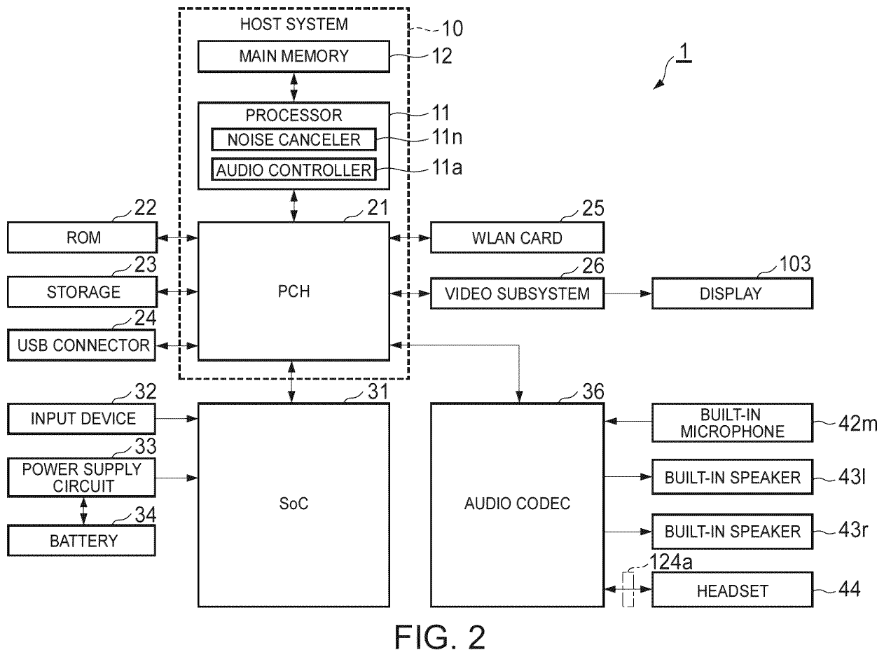

Next, a hardware configuration example of the electronic apparatus 1 according to one or more embodiments will be described. FIG. 2 is a schematic block diagram illustrating a hardware configuration example of the electronic apparatus 1 according to one or more embodiments. The electronic apparatus 1 includes a processor 11, a main memory 12, a platform controller hub (PCH) 21, a read-only memory (ROM) 22, a storage 23, a universal serial bus (USB) connector 24, a wireless local area network (WLAN) card 25, a video subsystem 26, a system-on-a-chip (SoC) 31, an input device 32, a power supply circuit 33, a battery 34, an audio codec 36, a built-in microphone 42m, the built-in speakers 431 and 43r, and the display 103.

The processor 11 is a device that forms a core of the electronic apparatus 1. The processor 11 includes a central processing unit (CPU), for example. The processor 11 enables to execute various arithmetic processes that are indicated by instructions described in various programs. For example, the processor 11 executes processes that are indicated by various programs, such as an operating system (OS), a basic input/output system (BIOS), firmware, and an application program (in the present application, may be called “application”).

The processor 11 executes the OS, and provides functions such as resource management, execution management of various programs, input/output control, and file management in the host system 10. The host system 10 is a computer system that forms a core of the electronic apparatus 1. Note that executing a process indicated by instructions (commands) described in a program may be referred to as “the execution of the program” or “to execute the program”.

The main memory 12 is a writable memory that is used as a reading area of the execution programs of the processor 11 or a working area for writing the processing data of the execution programs. The main memory 12 is composed of a plurality of dynamic random access memory (DRAM) chips, for example. The execution programs include the OS, various drivers for operating hardware such as peripheral devices, various services/utilities, applications, and the like.

The PCH 21 includes one or more bus controllers, and can be connected to the plurality of devices to be able to input and output various types of data. For example, the bus controller may be any one or any combination of the USB, a serial advanced technology attachment (ATA), a serial peripheral interface (SPI) bus, a peripheral component interconnect (PCI) bus, a PCI-Express bus, a low pin count (LPC), and the like. The plurality of devices to be connected include, for example, the ROM 22, the storage 23, the USB connector 24, the WLAN card 25, the video subsystem 26, and the SoC 31.

The processor 11, the main memory 12, and the PCH 21 constitute the host system 10. In other words, the computer system of the electronic apparatus 1 is configured to include system devices acting as hardware and software such as the OS and schedule/task.

Note that the processor 11 includes an audio controller 11a and a noise canceler 11n. The audio controller 11a and the noise canceler 11n may be realized by respectively executing specific programs and using some of arithmetic resources of the processor 11, or may be composed of dedicated arithmetic circuits. The functions of the audio controller 11a and the noise canceler 11n will be described later.

The display 103 displays a display screen based on display data output from the video subsystem 26. The display 103 may be any of a liquid crystal display (LCD), an organic light emitting diode (OLED) display, and the like, for example.

The ROM 22 stores therein the BIOS and firmware etc. for controlling operations of the SoC 31 and the other devices. The BIOS is firmware for performing basic input/output of the system devices. In the present application, the BIOS may also include firmware defined according to a specification prescribed in a unified extensible firmware interface (UEFI). The ROM 22 may be configured to include a rewritable nonvolatile memory.

The storage 23 is an auxiliary storage device that continuously stores various types of data in a rewritable manner. The data to be stored include various programs and parameters that may be executed by the processor 11, data to be used for various processes, and data to be acquired by various processes. The storage 23 may be any of a hard disk drive (HDD), a solid state drive (SSD), and the like, for example. The storage 23 is configured to include various nonvolatile memories. The various programs may include, for example, any one or any combination of the OS, a driver, firmware, an application, and the like.

The USB connector 24 is a connector for connecting various peripheral devices by using the USB by wire.

The WLAN card 25 is connected to a wireless (radio) LAN or the other network via the wireless LAN to enable various types of data to be transmitted and received by radio between a connection destination and the device.

The video subsystem 26 processes drawing commands from the processor 11, and writes drawing information obtained by the process to a video memory (not illustrated). The video subsystem 26 reads the drawing information from the video memory, and outputs it to the display 103 as display data indicating the drawing information (image processing). The drawing information output to the display 103 constitutes the display screen.

The SoC 31 is a one-chip microcomputer that monitors and controls statuses of various devices (peripheral devices, sensors, etc.) regardless of operating states of the host system of the electronic apparatus 1. The SoC 31 includes a processor separate from the processor 11, a RAM separate from the main memory 12, a ROM, a multi-channel analog-to-digital (A/D) input terminal, a digital-to-analog (D/A) output terminal, a timer, and an input-output interface, which are not illustrated. The SoC 31 executes predetermined firmware to perform functions thereof.

The input-output interface of the SoC 31 is connected to the input device 32, the power supply circuit 33, an audio system, and the other devices by wire or by radio. The SoC 31 can control operations of these devices. Moreover, the operations of the devices connected to the SoC 31 may be controlled in cooperation with the host system.

The input device 32 detects an operation of the user, and outputs an operation signal generated in response to the detected operation to the EC 31. The input device 32 corresponds to the keyboard 107 and the touch pad 109, for example. The input device 32 may further include a touch sensor. The touch sensor may be configured as a touch panel by overlapping the display 103 forming a display unit.

The power supply circuit 33 supplies power required for operations of the devices provided in the electronic apparatus 1 in accordance with the control of the EC 31. The devices to which power is supplied include the system devices as well as the peripheral devices. Moreover, the peripheral devices connected to the USB connector 24 may also be the supply destination of power. The operating voltages of the devices may be different individually. The various devices may also include a device that requests multiple-stage voltages. The multiple-stage voltages may include an operating voltage as well as a reference voltage.

The power supply circuit 33 includes a converter that converts a voltage of power supplied to itself and a power feeder that supplies the voltage-converted power to the battery 34. When the power is supplied from an AC adapter (not illustrated), the power feeder supplies the remaining power unused in each device to the battery 34. When the power is not supplied from the AC adapter or when the power supplied from the AC adapter is insufficient for power consumption by each device, the power feeder supplies power discharged from the battery 34 to each device as operating power.

For example, one or more DC/DC converters are used as the converter. The plurality of DC/DC converters may be used separately for the converted voltages. Moreover, first type converters that are some of the plurality of DC/DC converters may be connected to devices whose operating states may be different in accordance with the system devices or the operation modes of the system devices. The first type converters may control power to be supplied based on an operation mode notified by the EC 31. Second type converters that are other some of the plurality of DC/DC converters may be connected to devices that operate regardless of the operation modes of the system devices. The second type converters may be constantly capable of supplying a constant power.

The devices that operate regardless of the operation modes of the system devices include the SoC 31 etc., for example.

Based on the control of the power supply circuit 33, the battery 34 accumulates the power supplied from the power supply circuit 33. The battery 34 discharges a part of the accumulated power to the power supply circuit 33. A secondary battery is used as the battery 34. The secondary battery is a storage battery that can be charged and discharged. The secondary battery is a lithium ion battery, for example.

The AC adapter converts AC power supplied from an external power supply into DC power with a constant voltage, and supplies the converted power to the power supply circuit 33. The AC adapter includes a mounting fixture that can be attached to and detached from the chassis of the electronic apparatus 1 including the power supply circuit 33. The mounting fixture includes an interface that can transmit both of power and data in accordance with a predetermined standard.

Under the control of the host system 10, the audio codec 36 enables to execute sound pickup, recording, and playback. The host system 10 can execute a predetermined audio driver to provide functions of the audio codec 36. For example, the host system 10 executes a music playback application, reads voice data of musical pieces and other content designated by the operation of the user from the storage 23, and outputs the read voice data to the audio codec 36. The host system 10 executes a teleconference application, for example, and outputs the voice data acquired from the audio codec 36 to a counterpart device acting as a communication partner by using the WLAN card 25. The host system 10 outputs the voice data received from the counterpart device to the audio codec 36. The host system 10 may save the received and acquired voice data in the storage 23.

The audio codec 36 is connected to the built-in microphone 42m and the built-in speakers 431 and 43r. An input voice signal indicating a waveform of the voice picked up by the built-in microphone 42m is input into the audio codec 36. A voice having a waveform indicated by an output voice signal output from the audio codec 36 is presented to the built-in speakers 431 and 43r.

The audio connector 124a is connected to the audio codec 36, and enables to input and output the voice signal to and from an audio device connected to the audio connector 124a. In the example of FIG. 2, the headset 44 is connected to the audio connector 124a. In this state, the input voice signal may be input into the audio codec 36 from the headset microphone 442m. The output voice signal may be output to the receivers 4431 and 443r from the audio codec 36.

Next, a functional configuration example for a voice of the electronic apparatus 1 according to one or more embodiments will be described.

In the electronic apparatus 1, the audio controller 11a, the noise canceler 11n, and the audio codec 36 mainly execute voice processing.

In accordance with the control of the host system 10, the audio controller 11a executes and controls voice input/output processing. The audio controller 11a executes, for example, the control of sound pickup, playback, and the need for noise cancellation, the detection of the audio device connected to the audio connector 124a, the control of the need for the output of the output voice signal and the volume adjustment thereof, the selection of the output destination device, the control of the need for the input of the input voice signal and the volume adjustment thereof, the selection of the input source device, and the like.

Any one or any combination of the built-in speakers 431 and 43r and the external speaker connected to the audio connector 124a may be designated as the output destination device. The built-in microphone 42m or the external microphone connected to the audio connector 124a is designated as the input source device. Because the headset 44 includes the receivers 4431 and 443r that are external speakers and the headset microphone 442m that is an external microphone, the headset may be selected as the output destination device as well as the input source device.

In accordance with the control of the audio controller 11a, the audio codec 36 executes encoding into voice data and decoding of the encoded voice data. The audio codec 36 decodes the voice data input from the host system 10 to convert it into an output voice signal indicating a voice waveform. The audio codec 36 outputs the converted output voice signal to the output destination device. The audio codec 36 encodes the input voice signal input from the built-in microphone 42m or the audio connector 124a to convert it into voice data. The audio codec 36 outputs the converted voice data to the host system 10.

By using a preset well-known estimation model, the noise canceler 11n estimates a component (in the present application, may be called “environmental sound component”) of an environmental sound, which is a component other than a speech voice of the user, from an input voice signal input from the input source device. The environmental sound component includes ambient noise and sounds presented by the other sound sources. The audio controller 11a may previously learn characteristic data indicating characteristics of speech voices of individual users, set the characteristic data of the user to be designated by the host system 10 in the noise canceler 11n, and use it to estimate the environmental sound component. The noise canceler 11n subtracts an environmental sound signal indicating the estimated environmental sound component from the input voice signal to acquire an output signal indicating a voice component after the environmental sound component is removed.

In one or more embodiments, the audio controller 11a previously saves therein sensitivity for each model of the external microphone. In a state where the first chassis 101 and the second chassis 105 of the electronic apparatus 1 are open, for example, for the speech voice of the user located at a predetermined distance (e.g., 0.5 m to 0.8 m) from the front center of the electronic apparatus, the audio controller 11a measures (tunes) the sensitivity of the external microphone so that a level of the speech voice picked up by the built-in microphone 42m is equal to a level of the speech voice picked up by the external microphone, and saves the measured sensitivity.

The audio controller 11a determines whether the external microphone is connected to the audio connector 124a. The audio controller 11a monitors an electric potential generated at the audio connector 124a, for example, and determines that the external microphone is connected to the audio connector when the detected electric potential falls within a predetermined range. The external microphone transmits its own device information to a connection destination device acting as a connection destination in accordance with the input/output method with the audio connector 124a. The device information may include any one or any combination of a maker ID, a model ID, a serial number, and the like. The audio controller 11a specifies a model by using a model ID included in the device information received from the external microphone that is the connection destination. The audio controller 11a reads and sets the sensitivity of the specified model. A headset ID may be used as the model ID for the headset having the microphone.

Hereinafter, voice processing in the electronic apparatus 1 will be described by using a case where the headset 44 is connected to the audio connector 124a as an example, according to one or more embodiments.

The audio codec 36 acquires the voice signal input from the built-in microphone 42m as a first voice signal, and acquires a second voice signal with the set sensitivity from the headset microphone 442m provided in the headset 44 connected to the audio connector 124a. For that reason, levels of the speech voice component of the user of the electronic apparatus 1 that are respectively included in the first voice signal and the second voice signal are substantially equal.

The audio codec 36 outputs the acquired first voice signal and second voice signal to the noise canceler 11n, and acquires from the noise canceler 11n a first output signal and a second output signal whose environmental components are removed.

The audio controller 11a subtracts a larger amount of the second output signal from the first output signal to acquire an output signal as a level difference between the first voice signal and the second voice signal is larger.

More specifically, as illustrated in Equation (1), the audio controller 11a generates a weighted residual of the second output signal from the first output signal as the output signal. In Equation (1), P_{L1}, P_{L2}, and Y respectively indicate the level of the first output signal, the level of the second output signal, and the level of the output signal. Moreover, α indicates a preset gain, and B indicates a preset weight coefficient with respect to the second output signal.

$$Y = α ( {P}_{L 1} - β {P}_{L 2} ) \qquad ( 1 )$$

Note that, when the sound source of the well-known environmental sound does not move and comes to rest, the weight coefficient β may be set so that the level of the output signal is reduced more meaningfully than that of the first output signal (ideally, is canceled to zero) when the user of the electronic apparatus 1 does not utter. The environmental sound includes a speech voice of a person other than the user of the electronic apparatus 1, a playback sound presented from an audiovisual device, an operating sound of an air conditioner, and the like.

The acquired output signal may be used in executing various applications in the host system 10. The output signal is encoded by the audio codec 36 to be converted into voice data, for example, and is provided to a counterpart device in the teleconference. The counterpart device presents a voice based on the voice data received from the electronic apparatus 1. The environmental sound component in the presented voice is reduced, and the speech voice of the electronic apparatus 1 is mainly left. For that reason, the user of the counterpart device can clearly hear a voice of the user of the electronic apparatus 1.

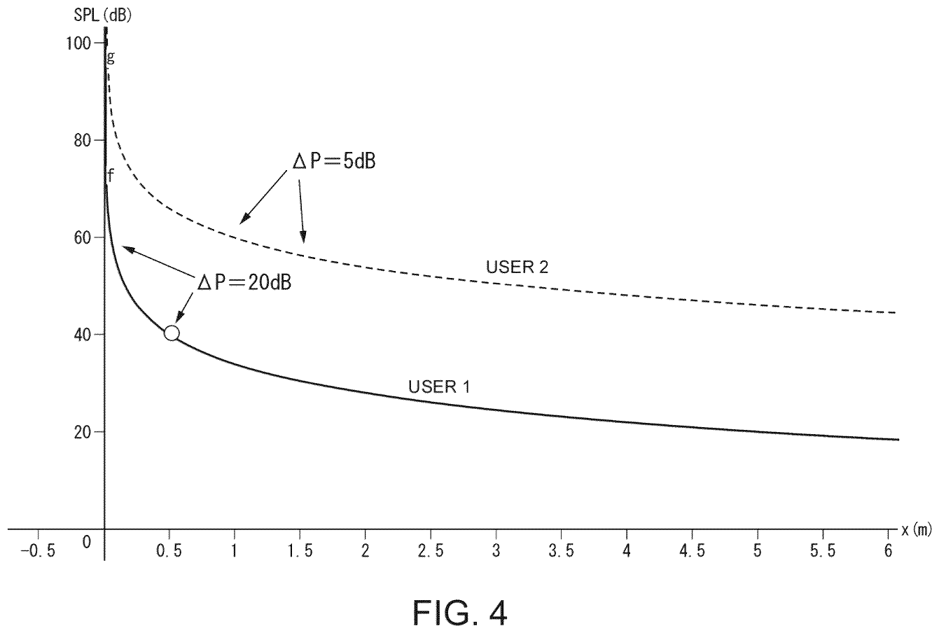

Typically, the level of the sound presented from the sound source is inversely proportional to the distance from the sound source. FIG. 4 exemplifies levels of speech voices of users 1 and 2 at the sound receiving point. The levels y of the speech voices of the users 1 and 2 are represented by “60+20 log(0.05/x)” and “60+20 log(1/x)”. Herein, x indicates a distance to the sound receiving point from the users 1 and 2 that are sound sources. A difference between the level P_{L1} of the first voice signal picked up by the headset microphone 442m and the level P_{L2} of the second voice signal picked up by the built-in microphone 42m becomes more remarkable as a difference between a distance L1 and a distance L2 is relatively larger as indicated by Equation (2).

$${P}_{L 2} = {P}_{L 1} + 20 log ( \frac{L 1}{L 2} ) \qquad ( 2 )$$

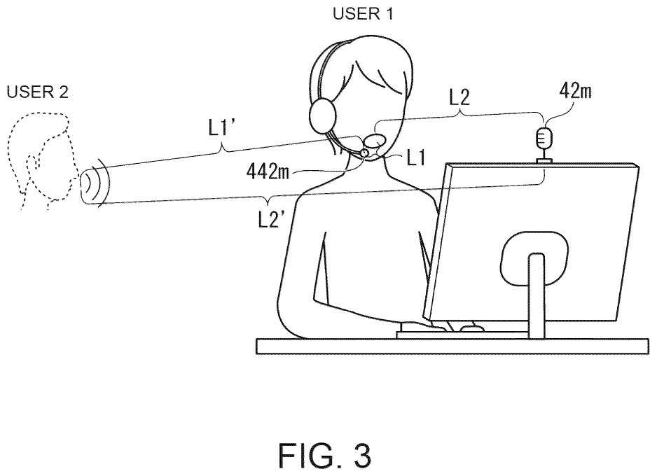

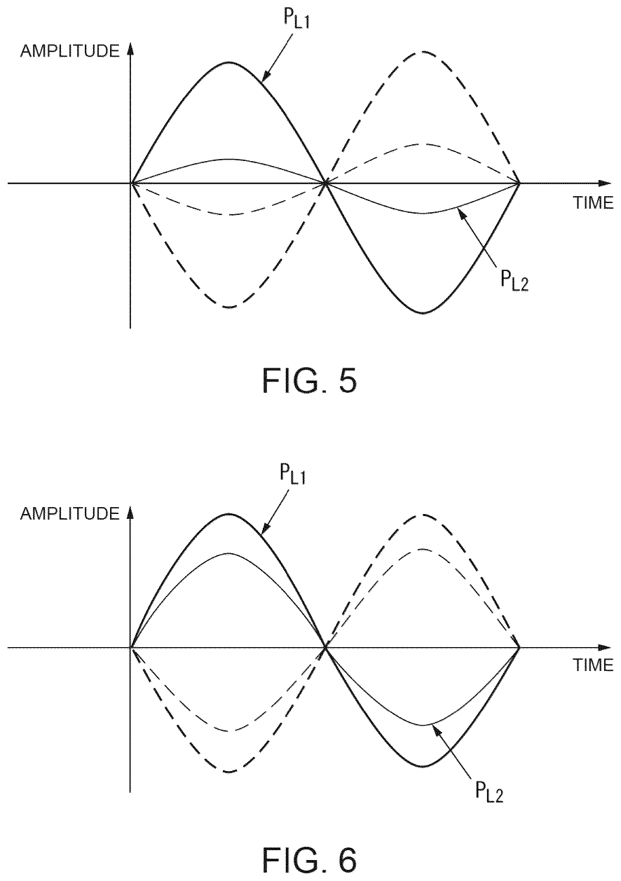

The headset microphone 442m is typically worn close to the mouth of the user 1 of the electronic apparatus 1 (see FIG. 3). The distance L1 from the user 1 to the headset microphone 442m is remarkably shorter than the distance L2 from the user 1 to the built-in microphone 42m. In the example of FIGS. 4 and 5, the level P_{L1} of the first voice signal picked up by the headset microphone 442m becomes 20 dB higher than the level P_{L2} of the second voice signal picked up by the built-in microphone 42m. On the other hand, a difference between the distance L1 from the user 2 who is a different person from the user 1 to the headset microphone 442m and the distance L2 from the user 1 to the built-in microphone 42m is relatively small. In the example of FIGS. 4 and 6, a level difference ΔP during speaking of the user 2 between the level P_{L1} of the first voice signal picked up by the headset microphone 442m and the level P_{L2} of the second voice signal picked up by the built-in microphone 42m is 5 dB, and this level difference is smaller than the level difference ΔP (=20 dB) during speaking of the user 1.

In the example of FIGS. 4 to 6, for the speech voice of the user 2 during being seated as the well-known environmental sound, the level P_{L1} of the first voice signal picked up by the headset microphone 442m is 60 dB, and the level P_{L2} of the second voice signal picked up by the built-in microphone 42m is 55 dB. Based on the levels P_{L1} and P_{L2}, the weight coefficient β may be previously set as 60/55 in the audio controller 11a. According to Equation (1), the level of the output signal Y related to the speech voice of the user 2 becomes substantially zero. On the other hand, for the speech voice of the user 1, the level P_{L1} of the first voice signal picked up by the headset microphone 442m is 60 dB, and the level P_{L2} of the second voice signal picked up by the built-in microphone 42m is 40 dB. According to Equation (1), the level of the output signal Y related to the speech voice of the user 2 becomes meaningfully larger than zero.

Therefore, even if the users 1 and 2 are simultaneously speaking, the speech voice of the user 1 is clearly shown because the output signal Y does not include the speech voice component of the user 2.

Note that the sensitivity as well as the weight coefficient β may be previously set in the audio controller 11a for each model of the external microphone. The audio controller 11a may read the weight coefficient β according to the specified model and generate the output signal Y by using the read weight coefficient β. Furthermore, a gain a may be previously set in the audio controller 11a as an index of the sensitivity for each model of the external microphone. In that case, the audio controller 11a may read the gain a according to the specified model and generate the output signal Y by using the read the gain a. As a result, an output voice clearly indicating the user's own speech voice is obtained even when the sensitivities and configurations are different depending on the model.

In one or more embodiments, as the level difference between the first voice signal by the built-in microphone 42m and the second voice signal by the headset microphone 442m is larger, the second voice signal is more subtracted from the first voice signal. The difference between the distance from the sound source to the built-in microphone 42m and the distance from the sound source to the headset microphone 442m becomes relatively larger as the level difference is larger, and thus it is assumed that the sound source approaches the built-in microphone 42m. The output signal obtained in the state where the level difference is large meaningfully contains the speech voice component of the user 1 of the electronic apparatus 1 wearing the headset 44, and cancels therefrom the environmental sound component by the other sound source (e.g., the speech voice of the user 2).

Therefore, according to one or more embodiments, the output signal clearly indicating the speech voice of the user 1 is obtained.

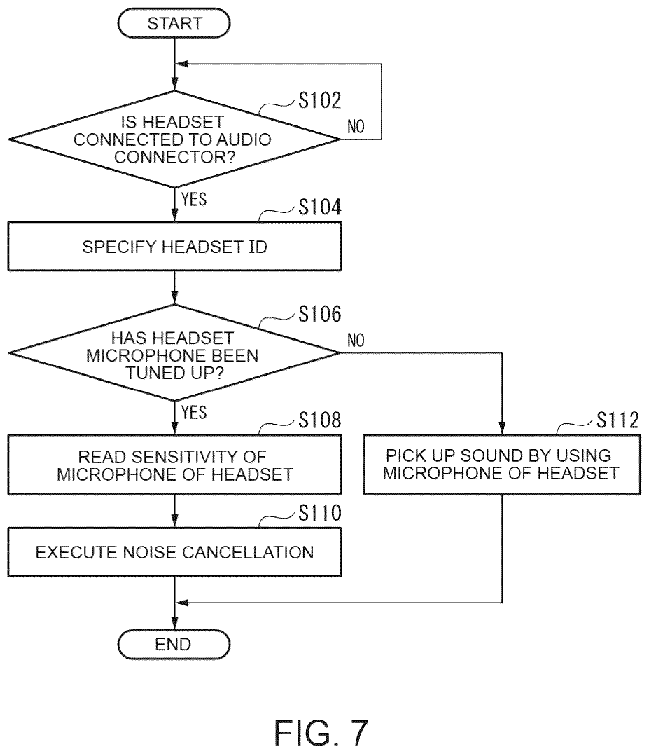

Next, an example of voice processing according to one or more embodiments will be described. FIG. 7 is a flowchart exemplifying voice processing according to one or more embodiments.

(Step S102) The audio controller 11a determines whether the headset 44 is connected to the audio connector 124a. When the connection of the headset 44 is detected (Step S102: YES), the controller proceeds to the process of Step S104. When the connection of the headset 44 is not detected (Step S102: NO), the controller repeats the process of Step S102.

(Step S104) The audio controller 11a receives device information from the headset 44, and specifies a headset ID from the received device information as an example of a model ID.

(Step S106) The audio controller 11a determines whether the headset microphone 442m related to the specified headset ID has been tuned up. Depending on whether there is a set of the model ID and microphone sensitivity, which matches the specified headset ID, among sets of a model ID and a microphone sensitivity for microphones or headsets set in itself, the audio controller 11a can determine whether the headset microphone has been tuned up. When the headset microphone has been tuned up (Step S106: YES), the controller proceeds to the process of Step S108. When the headset microphone has not been tuned up (Step S106: NO), the controller proceeds to the process of Step S112.

(Step S108) The audio controller 11a adds the headset microphone 442m to the built-in microphone 42m as an input source device. The audio controller 11a reads sensitivity of a microphone corresponding to the headset ID, and starts sound pickup of the first voice signal by using the headset microphone 442m at the read microphone sensitivity.

(Step S110) The audio controller 11a causes the noise canceler 11n to execute noise cancellation on the first voice signal input from the headset microphone 442m and the second voice signal input from the built-in microphone 42m. The audio controller 11a generates an output signal from the first output signal and the second output signal acquired from the noise canceler 11n in accordance with Equation (2). After that, the controller terminates the process of FIG. 7.

(Step S112) The audio controller 11a switches the input source device from the built-in microphone 42m to the headset microphone 442m, and starts sound pickup of the first voice signal by using the headset microphone 442m. At this time, the noise canceler 11n may not execute noise cancellation on the first voice signal. After that, the controller terminates the process of FIG. 7.

Note that the case where the electronic apparatus 1 is configured as the laptop PC has been explained in the above description but the embodiments are not limited to this. The electronic apparatus 1 may be configured as another type of information terminal apparatus such as a portable telephone and a tablet terminal apparatus. Moreover, the case where the headset 44 can be attached to and detached from the audio codec 36 by wire by using the audio connector 124a has been exemplified, but the embodiments are not limited to this. The headset 44 may be capable of wirelessly transmitting and receiving various signals and data to and from the audio codec 36 in an intermittent manner. Moreover, the first microphone is not limited to the headset microphone 442m, and may use a microphone that is supported by a support member that allows the wearing of the microphone in proximity to the user of the electronic apparatus 1. For example, a head mounted display with a built-in microphone or a mask-type microphone may be used instead of the headset 44.

As described above, the electronic apparatus 1 according to one or more embodiments includes an interface (e.g., the audio connector 124a) to which a first microphone (e.g., the headset microphone 442m) is connectable, a second microphone (e.g., the built-in microphone 42m), and a controller (e.g., the audio controller 11a and the noise canceler 11n) configured to remove an environmental sound component that is a component separate from a speech voice from a first voice signal picked up from the first microphone and a second voice signal picked up from the second microphone to acquire a first output signal and a second output signal. The controller subtracts a larger amount of the second output signal from the first output signal to acquire an output signal as a level difference between the first voice signal and the second voice signal is larger.

According to one or more embodiments, as the level difference for each sound source between the first voice signal and the second voice signal is larger, the second voice signal is more subtracted from the first voice signal. The difference between the distance from the sound source to the first microphone and the distance from the sound source to the second microphone becomes relatively larger as the level difference is larger, and it is assumed that the sound source approaches the second microphone. The output signal obtained in the state where the level difference is large meaningfully contains the speech voice component of the user of the electronic apparatus 1 approaching the second microphone, and cancels therefrom the environmental sound component due to the other sound source. Therefore, the clear speech voice of the user is obtained.

The controller may previously set sensitivities for models of the first microphone, determine, among the models, a model of the first microphone when detecting connection with the first microphone, and acquire the first voice signal based on a sensitivity of the determined model among the sensitivities.

According to one or more embodiments, the sensitivity of the first microphone is adjusted. For that reason, regardless of the difference between the sensitivities of the first microphone depending on the models, the environmental sound component due to the other sound source can be canceled.

The controller may detect connection between the first microphone and the interface, and determine the model of the first microphone based on device information (e.g., the microphone ID or the headset ID) input from the first microphone.

According to one or more embodiments, the model of the first microphone is determined without performing a special operation of the user. Consequently, the sensitivity of the first microphone is adjusted based on the determined model.

The first microphone may be arranged integrally with a reproduced sound source that is wearable on a head of the user.

According to one or more embodiments, because the first microphone is stably provided in proximity to the user, it is possible to maintain the level difference between the first voice signal and the second voice signal during speaking of the user.

The controller may acquire a weighted residual of the second output signal from the first output signal as the output signal, and set a weight coefficient in the weighted residual for the second output signal so that the output signal is canceled when the user does not speak and another sound source pronounces. According to one or more embodiments, the environmental sound component is canceled from the output signal acquired when the other sound source is pronouncing. The clear speech voice is obtained by canceling the environmental sound component even in the state where the other sound source is pronouncing during speaking of the user.

As described above, although embodiments of the present invention has been described in detail with reference to the accompanying drawings, the specific configurations are not limited to the above-described embodiments, and designs etc. that do not depart from the scope of the present invention are also included. The configurations described in the above embodiments can be arbitrarily combined.

### DESCRIPTION OF SYMBOLS

1 electronic apparatus
11 processor
11a audio controller
11n noise canceler
12 main memory
21 PCH
22 ROM
23 storage
24 USB connector
25 WLAN card
26 video subsystem
31 SoC
32 input device
33 power supply circuit
34 battery
36 audio codec
42m built-in microphone
431, 43r built-in speaker
44 headset
101 first chassis
103 display
105 second chassis
107 keyboard
109 touch pad
113 power button
121a, 121b hinge mechanism
124a audio connector
442m headset microphone
4431, 443r receiver

What is claimed is:

1. An electronic apparatus comprising:
an interface to which a first microphone is connectable;
a second microphone; and
a controller configured to remove an environmental sound component that is a component separate from a speech voice from a first voice signal picked up from the first microphone and a second voice signal picked up from the second microphone to acquire a first output signal and a second output signal, wherein
the controller is configured to subtract a larger amount of the second output signal from the first output signal to acquire an output signal, as a level difference between the first voice signal and the second voice signal is larger.

2. The electronic apparatus according to claim 1, wherein
the controller is configured to:
previously set a sensitivity for each of models of the first microphone;
determine, among the models, a model of the first microphone when detecting connection with the first microphone; and
acquire the first voice signal based on the sensitivity of the model.

3. The electronic apparatus according to claim 2, wherein
the controller is configured to:
detect connection between the first microphone and the interface; and
determine the model of the first microphone based on device information input from the first microphone.

4. The electronic apparatus according to claim 1, wherein the first microphone is arranged integrally with a reproduced sound source that is wearable on a head of a user.

5. The electronic apparatus according to claim 1, wherein
the controller is configured to:
acquire a weighted residual of the second output signal from the first output signal as the output signal; and
set a weight coefficient in the weighted residual for the second output signal so that the output signal is canceled when a user does not speak and another sound source pronounces.

6. A voice processing method for an electronic apparatus that includes an interface to which a first microphone is connectable and a second microphone, comprising:
removing an environmental sound component that is a component separate from a speech voice from a first voice signal picked up from the first microphone and a second voice signal picked up from the second microphone to acquire a first output signal and a second output signal; and
subtracting a larger amount of the second output signal from the first output signal to acquire an output signal, as a level difference between the first voice signal and the second voice signal is larger.
